(19) United States
(12) Patent Application Publication
(10) Pub. No.: US 2007/0177799 A1
(43) Pub. Date: Aug. 2, 2007

(54) Image analysis

(75) Inventor: Anastasia Tyurina, Needham, MA (US)

Correspondence Address: EDWARDS ANGELL PALMER & DODGE LLP, P.O. BOX 55874, BOSTON, MA, 02205, US

(73) Assignee: Helicos BioSciences Corporation, Cambridge, MA (US)

(21) Appl. No.: 11/345,730

(22) Filed: Feb. 1, 2006

(51) Int. Cl. G06K 9/00

(52) U.S. Cl. 382/181

(57) ABSTRACT

Images with closely spaced objects can be processed using a deblending procedure that includes the calculation of some moments and centroids of intensity data. Methods and apparatus for performing this processing are well-suited for use in DNA sequencing, where the locations of fluorescing nucleotides appearing in images must be compared across several images and can be very close to one another in any single image. The increased accuracy and resolution provided by embodiments of the invention reveals previously undetected or misdetected fluorescing nucleotides, thereby facilitating the sequencing process. Embodiments of the invention can be used in other applications where, for example, defects in testing apparatus and/or limitations on image resolution frustrate subsequent analyses.

### TECHNICAL FIELD

The present invention generally relates to image analysis.

### BACKGROUND INFORMATION

Image analysis often requires a determination of whether an observed object is a single object or whether it is made up of several overlapping objects. When objects in an image are spaced closer together than the resolving power of the optics, several closely spaced objects can erroneously appear as one large object.

Software exists to process electronic (i.e., digitized) representations of images. The processing includes operations performed on the digital image data to effectively increase the resolution of the image and attempt to minimize or eliminate image artifacts. An example is a software application called Source Extractor, which is used to process and deblend astronomical images. Deblending is the process of attempting to determine whether an observed object is a single object or a collection of closely-spaced, but separate objects.

Deblending in Source Extractor is performed by examining an intensity profile of the objects appearing in an image and comparing that profile to a threshold. This is described in, for example, B. W. Holwerda, Source Extractor for Dummies 32-34 (Space Telescope Science Institute, Baltimore, Md.) and also in E. Bertin, SExtractor v2.3 User's Manual 20-22 (Institue d'Astrophysique & Observatoire de Paris). This technique is generally unable to resolve individual objects that are closer than about four pixels.

### SUMMARY OF THE INVENTION

The invention generally relates to image processing techniques that improve the resolution of objects appearing in an image. The improved images can then be used in further analyses. In accordance with one aspect of the invention, images containing objects arranged very close together are processed and individual objects are distinguished from clusters of objects. Embodiments of the invention are useful to detect single molecules appearing in a dense field of objects. In a highly-preferred embodiment, single molecules labeled with an optically-detectable reporter are detected. The increased accuracy and resolution provided by the invention reveals previously undetected or misdetected single objects.

The present invention provides, in one aspect, methods and apparatus for facilitating the accurate detection of objects appearing in an image, such as single fluorescent molecules. The invention provides resolution of closely-spaced objects without the need to perform intensive, time-consuming computations.

In one particular embodiment according to the invention, a method of image analysis includes providing a representation of a sample image that contains intensity and centroid (coordinates of object centers) data for objects in the image. A deblending procedure is performed on the representation, which involves computing several moments corresponding to the intensity data. The moments allow the characteristics (e.g., position and/or intensity) of the sample objects to be computed. The number of mathematical moments that are calculated depends upon the number of objects that one wishes to resolve as taught below.

Determination of moments associated with an object or objects allows computation of parameter, such as a revised centroid, that allow an observed object to be “fit” to one or more known objects. For example, single fluorescent molecules in a microscopic field of view have a known point spread function. In determining whether a given observed object is a single object, moments are determined as taught below, with the result being the determination whether the point spread function matches that of the known single object.

Thus, in one embodiment of the invention, a deblending procedure includes the use of a point spread function to characterize object intensity data. The intensity data are fit to the point spread function, the effect of the now fitted point spread function is subtracted from the intensity data, and then moments representative of the intensity data are computed. The moments are then used to calculate centroids of the objects. The process can be repeated one or more times to refine the intensity data. This generally improves resolution of closely spaced objects.

In a particular alternative aspect, methods of the invention are used to detect the incorporation of single fluorescent-labeled nucleotides into a single surface-bound nucleic acid duplex in a template-directed sequencing-by-synthesis reaction, as detailed below.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 is a flowchart depicting a method for image analysis in accordance with an embodiment of the invention;

FIG. 2 is a flowchart depicting a method for deblending a representation of an image in accordance with an embodiment of the invention;

FIG. 3A is a depiction of a representation of an image before deblending in accordance with an embodiment of the invention;

FIG. 3B is a depiction of a representation of an image after deblending in accordance with an embodiment of the invention;

FIG. 4A depicts a single peak intensity profile;

FIG. 4B is a theoretical projection of the intensity profile depicted in FIG. 4A;

FIG. 4C depicts a view of a dual peak intensity profile;

FIG. 4D depicts an alternate view of the dual peak intensity profile shown in FIG. 4C;

FIG. 4E is a theoretical projection of the intensity profile depicted in FIGS. 4C and 4D;

FIG. 4F depicts another dual peak intensity profile;

FIG. 4G depicts a planar view of the dual peak intensity profile shown in FIG. 4F;

FIG. 4H is a theoretical projection of the intensity profile depicted in FIGS. 4F and 4G;

FIG. 5 is a block diagram depicting image analysis apparatus in accordance with an embodiment of the invention;

FIG. 6 is a representation of image analysis apparatus in accordance with an embodiment of the invention; and

FIG. 7 depicts a series of intensity peaks for correlation in accordance with an embodiment of the invention.

### DESCRIPTION

As shown in the drawings for the purposes of illustration, the invention may be embodied in methods and apparatus for analyzing images acquired during DNA sequencing. Embodiments of the invention are useful for minimizing or eliminating image artifacts that compromise the accuracy of detection. Application of methods of the invention to nucleic acid sequencing is used to demonstrate the utility of the invention. The skilled artisan understands that the principles of the invention are useful in any application in which high-resolution single object detection is desired, e.g., including applications involving diffraction limited or other symmetrical objects.

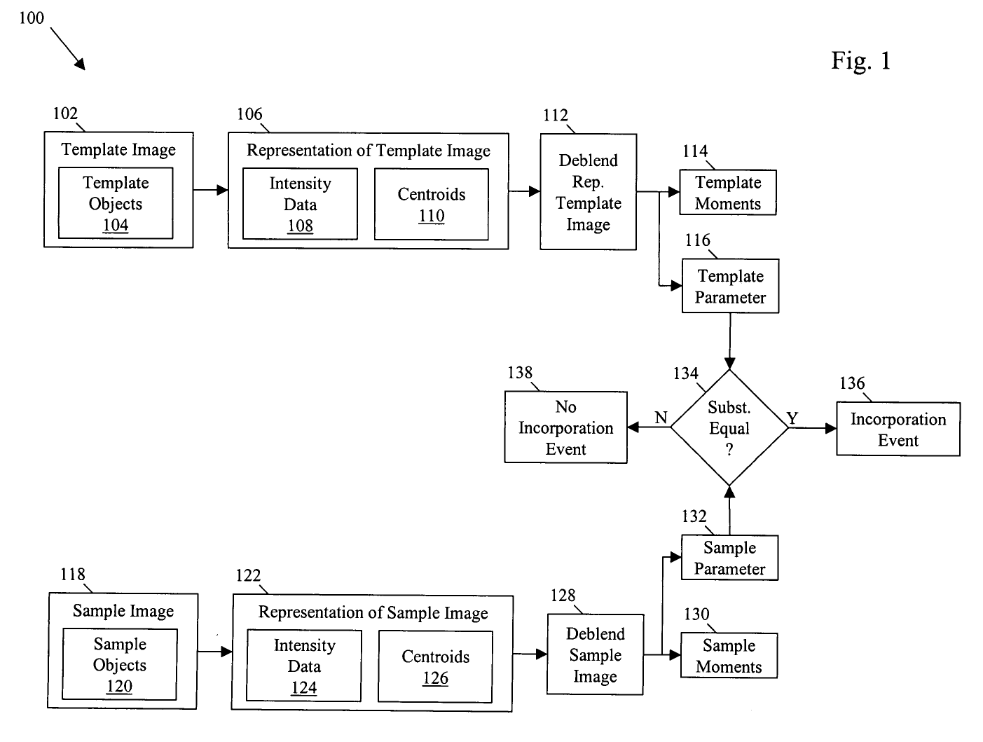

In brief overview, FIG. 1 is a flowchart depicting a method 100 for image analysis in accordance with an embodiment of the invention.

In the context of DNA sequencing, embodiments of the invention are used to identify the incorporation into a template/primer duplex of single, labeled nucleotide at a discrete location on a surface. The basic process includes attaching nucleic acid duplex (comprising a template hybridized to a primer) to a surface, such as glass or fused silica (the specific type of surface is immaterial to the present invention, but should be selected to be compatible with the type of label used). The attached duplex is then exposed to an optically-labeled nucleotide that hybridizes to the next available nucleotide in the template (available meaning just 3′ of the template terminus) and a polymerizing enzyme capable of incorporating the labeled nucleotide into the primer. Incorporation is determined by observing the optically-detectable label at the known location of the duplex. For example, if the optically-detectable label is a fluorescent label, then illumination at the appropriate wavelength is used to stimulate fluorescence of the label. The invention allows one to determine whether a single optically-labeled nucleotide has been incorporated or whether there are multiple duplexes, non-specific label, dirt, etc. that overlap.

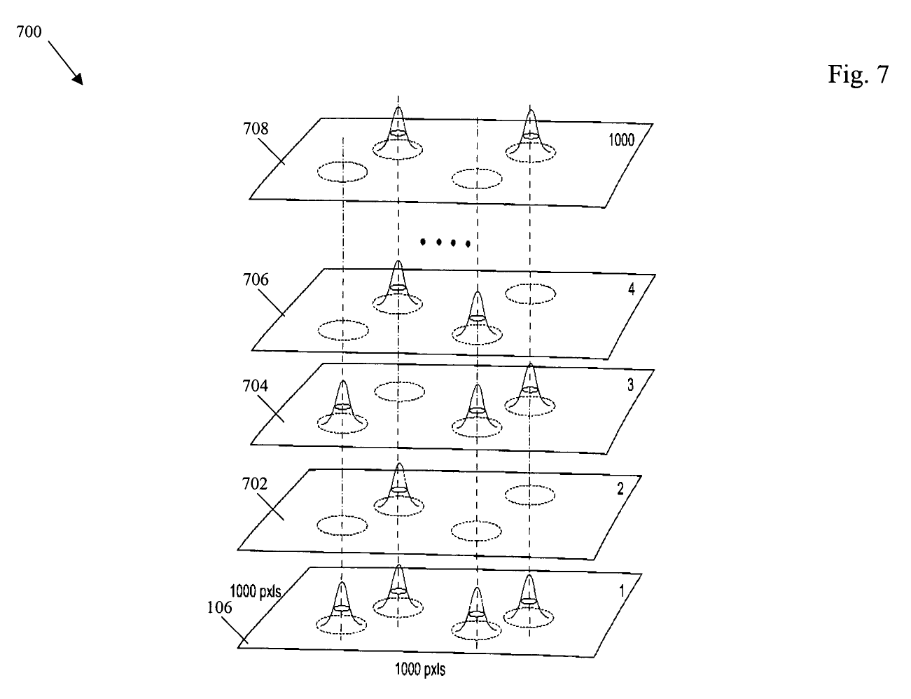

An image acquired after each incorporation step (i.e., a sample image 118) shows the location of each specific fluorescing nucleotide (i.e., sample objects 120 ). DNA sequencing includes comparing the location of each sample object 120 with the location of each template object 104 (i.e., the expected object location). If the locations correspond, an “incorporation event” occurred. In other words, there is confirmation that a specific nucleotide is present in that part of the DNA strand. If the locations do not correspond (e.g., the fluorescence of the sample object 120 is due to a defect in the testing apparatus), then the specific nucleotide is not considered present in that part of the DNA strands. The process of incorporation is repeated until a desired number of incorporations has been reached. At the end of this process the sequence of the nucleotides in the template is known. This is discussed below in connection with FIG. 7.

Defects in the testing apparatus and limitations on image resolution can hide or misidentify single fluorescent objects, thereby compromising the accuracy of the data.

In embodiments of the invention, an image 102 is acquired using, for example, a personal computer with an image capture card. The image is recorded in one or more electronic files, typically in the “FITS” (Flexible Image Transport System) format. A photometry program then operates on the FITS files. One such program is Source Extractor, which is typically used in astronomical studies. The photometry program detects the intensities and locations of the fluorescence (i.e., the template objects 104) and generates a representation of the image 106 that includes a table or catalog containing intensity data 108 and the centroids 110 of the objects 104. The intensity data 108 generally follow a Gaussian distribution, and the centroids 110 are typically the coordinates of the centers of the identified objects 104.

A problem with the representation of the image 106 is that photometry programs generally have a limited ability to identify or resolve a number of closely spaced objects 104. For example, the photometry programs can erroneously interpret two discrete, closely spaced objects 104 as single large object. This can occur if the objects 104 are closer than, for example, four pixels. To minimize or eliminate this problem, embodiments of the invention subject the representation of the image 106 to post-processing known as deblending 112.

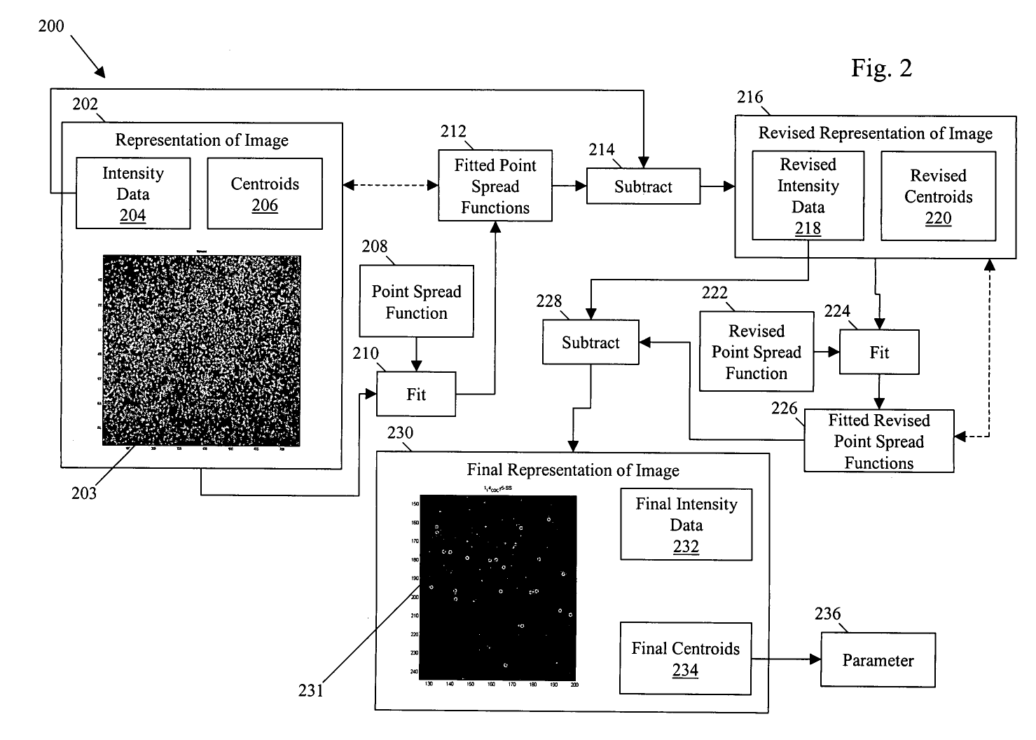

Deblending 112, described more fully below in connection with FIG. 2, examines the intensity data 108 (collectively, the intensity flux), and computes several axially-specific, zero-, and higher-order moments 114 of the intensity flux. A result is a series of equations that are solved simultaneously to yield a template parameter 116 that, in some embodiments, includes corrected values for the centroids 110. The corrections have the effect of revealing locations of additional objects 104 that were previously unresolvable.

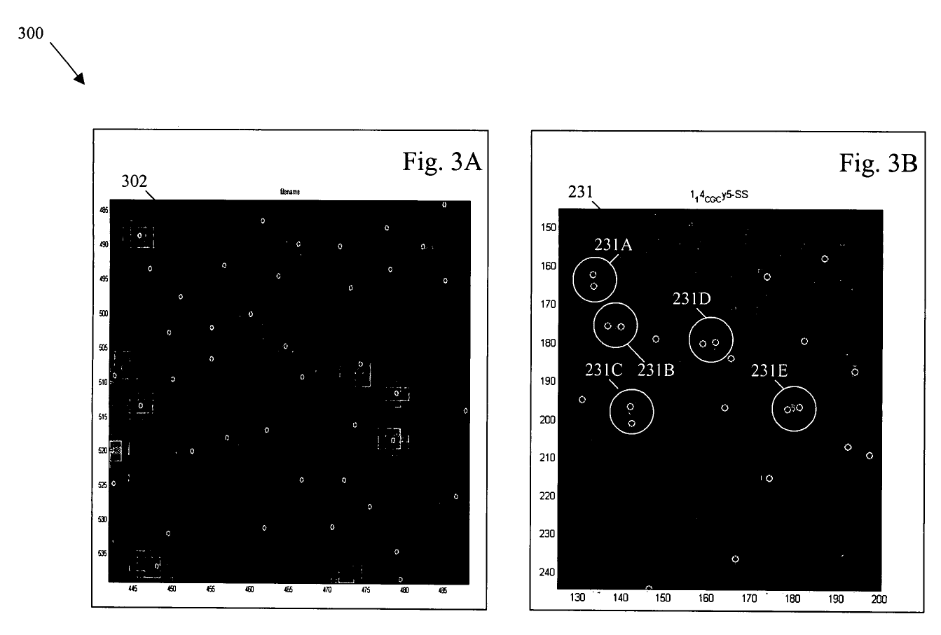

FIG. 2 is a flowchart depicting a method for deblending 200 in accordance with an embodiment of the invention. A representation of the image 202 includes, as described above, intensity data 204 and centroids 206 of the fluorescing objects therein. The fluorescing objects generally appear in a constellation-like form 203. When the representation of the image 202 includes many large and closely spaced fluorescing objects, for example, as shown in illustration 302 in FIG. 3A, deblending 200 operates to minimize or eliminate artifacts that could prevent a proper analysis.

The intensity data 204 for each fluorescing object are typically follow a curve that can be approximated by a known point spread function 208, such as a Gaussian function or a sine cardinal (“sinc”) function. In the case of the Gaussian function, the intensity data 204 (collectively, the intensity flux “F(x, y)”) for a fluorescing object is given by Equation 1:

$$F ( x , y ) = \frac{F}{π {σ}^{2}} {ⅇ}^{\frac{- {( x - {μ}_{1} )}^{2} - {( y - {μ}_{2} )}^{2}}{2 {σ}^{2}}} \qquad Equation 1$$

Where F(x, y) is the flux at a location given by coordinates (x, y), μ₁ and μ₂ are the x- and y-coordinates (i.e., centroid) of the fluorescing object, σ is the standard deviation, and F is the maximum intensity. In the case where there are two nearby fluorescing objects, Equation 2 gives the flux:

$$F ( x , y ) = \frac{{F}_{1}}{π {σ}^{2}} {ⅇ}^{\frac{- {( x - {μ}_{1 x} )}^{2} - {( y - {μ}_{1 y} )}^{2}}{2 {σ}^{2}}} + \frac{{F}_{2}}{π {σ}^{2}} {ⅇ}^{\frac{- {( x - {μ}_{2 x} )}^{2} - {( y - {μ}_{2 y} )}^{2}}{2 {σ}^{2}}} \qquad Equation 2$$

Where (μ₁ₓ, μ_{1y}) and (μ₂ₓ, μ_{2y}) are the (x, y) coordinates (i.e., centroid) of the first and second fluorescing objects, respectively.

The intensity data 204 and centroid 208 for each fluorescing object are then fit 210 to the known point spread function 208. Data are fit according to Equation 2A:

$${L}_{2 - fit} = \int \int {( \frac{{F}_{image} ( x , y ) - E}{E} )}^{2} ⅆ x ⅆ y \qquad Equation 2 A$$

(Where “E” is either Equation (1) or Equation (2), depending on whether there are one or two objects, and F_{image}(x, y) is the actual image data.) A result is a series of fitted point spread functions 212, one for each fluorescing object in the representation of the image 202. Next, the effect of a quantity of the fitted point spread functions 212 is subtracted 214 from the representation of the image 202. In other words, intensity data generated by a quantity of the fitted point spread functions 212 is subtracted 214 from the intensity data 204 in the representation of the image 202. The number of fitted point spread functions 212 used to generate the data to be subtracted can be based on a pixel distance between the centroids of the fluorescing objects or, in the alternative, a fixed pixel distance (e.g., six pixels). Also, the number can be based on a characteristic of the object intensity data, such as the full-width half-maximum (“FWHM”) of the known point spread function 208. In the case of the Gaussian function, the FWHM is given by Equation 3:
FWHM=2σ\sqrt{2 ln 2}≈2.3548σ Equation 3

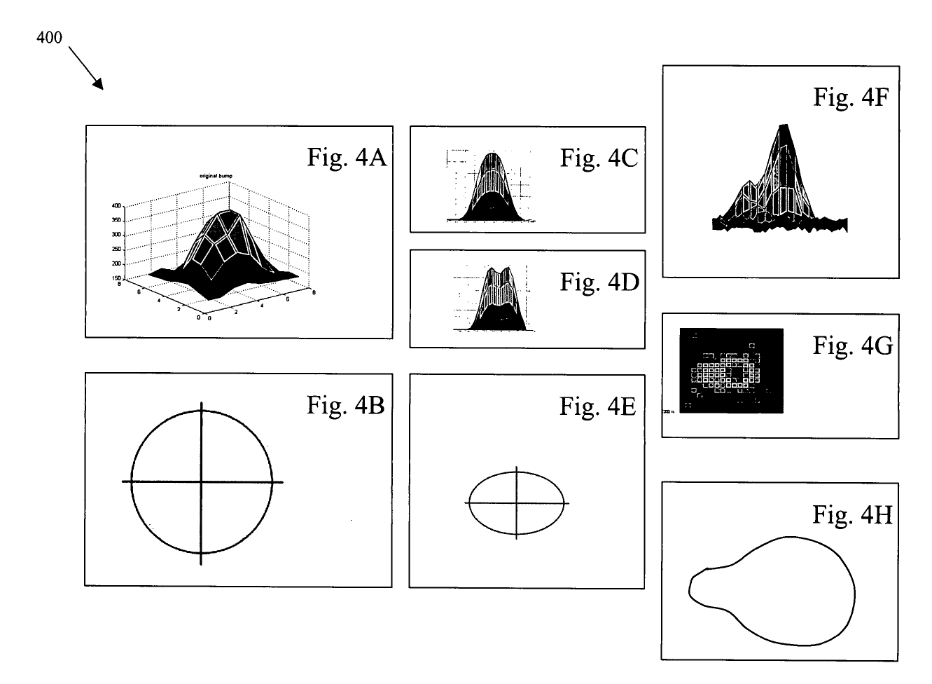

The subtraction 214 yields a revised representation of the image 216 that includes revised intensity data 218. In some embodiments, several axially-specific, zero-, and higher-order moments of the revised representation of the image 216 (i.e., moments of the revised intensity data 218 associated with each fluorescing object) are computed, as shown in Equations 4 through 13:
M₀=∫∫F(x,y)dxdy Equation 4
M₁ₓ=∫∫xF(x,y)dxdy Equation 5
M_{1y}=∫∫yF(x,y)dxdy Equation 6
M₂ₓₓ=∫∫x²F(x,y)dxdy Equation 7
M_{2xy}=∫∫xyF(x,y)dxdy Equation 8
M_{2yy}=∫∫y²F(x,y)dxdy Equation 9
M₃ₓₓₓ=∫∫x³F(x,y)dxdy Equation 10
M_{3yxx}=∫∫yx²F(x,y)dxdy Equation 11
M_{3yyx}=∫∫y²xF(x,y)dxdy Equation 12
M_{3yyy}=∫∫y³F(x,y)dxdy Equation 13
Equation 4 represents the zero-order moment, and Equations 5 and 6 represent the first-order moments of the intensity data 218 having a single peak, as shown in FIG. 4A, with the corresponding theoretical projection shown in FIG. 4B. Equations 7, 8, and 9 represent second order moments, which can be important in instances where the intensity data 218 have two peaks, as shown in FIG. 4C and, in alternate view, FIG. 4D, with the corresponding theoretical projection shown in FIG. 4E. Equations 10, 11, 12, and 13 represent third order moments, which can also be important in instances where the intensity data 218 have two peaks arranged, for example, as shown in FIGS. 4F and 4G, with the corresponding theoretical projection shown in FIG. 4H. The area of integration for Equations 4 through 13 is typically limited to the FWHM value of each corresponding fluorescing object. In some embodiments, the area of integration is limited to a fixed number of pixels, such as six pixels.

Note that it may be necessary to rotate the coordinate system used in Equations 7 through 13 by an angle “theta” (θ) to align with another coordinate system. This is accomplished using the well-known coordinate transformation matrix for tensors. Consequently, Equations 7 through 13 can be restated as follows:
M₂ₓₓ(θ)=M_{yy} sin²θ+2M_{xy} sin θ cos θ+Mₓₓ cos²θ Equation 7A
M_{2xy}(θ)=(M_{yy}−Mₓₓ)sin θ cos θ+M_{xy}(cos²θ−sin²θ) Equation 8A
M_{2yy}(θ)=Mₓₓ sin²θ−2M_{xy} sin θ cos θ+M_{yy} cos²θ Equation 9A
M₃ₓₓₓ(θ)=M₃ₓₓₓ cos³θ+3M_{3xxy} sin θ cos²+3M_{3xyy} sin²θ cos θ+M_{3yyy} sin³θ Equation 10A
M_{3xxy}(θ)=M_{3yyy} sin²θ cos θ−M_{3xyy}(sin³θ−2 sin θ cos²θ)+M_{3xxy}(cos³θ−2 sin²θ cos θ)−M₃ₓₓₓ sin θ cos²θ Equation 11A
M_{3xyy}(θ)=M₃ₓₓₓ sin²θ cos θ+M_{3xxy}(sin³θ−2 sin θ cos²θ)+M_{3xyy}(cos³θ−2 sin²θ cos θ)+M_{3yyy} sin θ cos²θ Equation 12A
M_{3yyy}(θ)=M_{3yyy} cos³θ−3M_{3xyy} sin θ cos²θ+3M_{3xxy} sin²θ cos θ−M₃ₓₓₓ sin³θ Equation 13A

Assuming the flux F(x, y) is given by Equation 2, Equations 4 through 13 simplify to the following due to symmetry with respect to the x-axis that is a result of the coordinate transformation described above:
M₀=F₁+F₂ Equation 14
M₁=M₁ₓ=μ₁F₁+μ₂F₂ Equation 15
M₂=Mₓₓ=σ²(F₁+F₂)+F₁μ₁²+F₂ μ₂² Equation 16
M₃=Mₓₓₓ=¾μ₁σ²F₁+¾μ₂σ²F₂+μ₁³F₁+μ₂³F₂ Equation 17

To solve the system of Equations 14-17, first define the following quantities:

$$\begin{matrix}C ≡ \frac{{M}_{3 x x x} {σ}^{2}}{2 {M}_{y y} ( \frac{{σ}^{2}}{2} ) ( \frac{{M}_{x x}}{{M}_{y y}} - 1 ) \sqrt{( \frac{{σ}^{2}}{2} ) ( \frac{{M}_{x x}}{{M}_{y y}} - 1 )}} & Equation 18 \\ X ≡ \frac{{σ}^{2}}{2} ( \frac{{M}_{x x}}{{M}_{0}} - 1 ) & Equation 19 \\ f ≡ \frac{{F}_{1}}{{F}_{2}} & Equation 20\end{matrix}$$

Combining Equations 14-23 yields the revised centroid 220 of a fluorescing object:

$$\begin{matrix}{μ}_{1} = \frac{\sqrt{X}}{f} & Equation 24 \\ {μ}_{2} = - {μ}_{1} f & Equation 25\end{matrix}$$

The coordinates (μ₁, μ₂) given by Equations 24 and 25 represent the revised (x, y) location of a fluorescing object in the revised representation of the image 216. In other words, each fluorescing object subjected to deblending 200 has its initial centroid 206 recomputed to yield a revised centroid 220, thereby reducing the effects of image artifacts.

Next, in some embodiments, a revised object set is determined for each fluorescing object by replacing the original centroid 206 with a pair of centroids (μ₁, μ₂). In the case of the Gaussian function (i.e., Equations 1 and 2), the x₀ coordinate is changed to the values computed by Equations 24 and 25 for each fluorescing object.

The revised intensity data 218 and revised centroid 220 for each fluorescing object are then fit 224 to the revised point spread function 222. A result is a series of fitted revised point spread functions 226, one for each fluorescing object in the revised representation of the image 216. Next, the effect of a quantity of the fitted revised point spread functions 226 is subtracted 228 from the revised representation of the image 216. Similar to that described above, intensity data generated by a quantity of the fitted revised point spread functions 226 is subtracted 228 from the revised intensity data 218 in the revised representation of the image 216. The number of fitted revised point spread functions 226 used to generate the data to be subtracted can be based on a pixel distance between the revised centroids of the fluorescing objects or, in the alternative, a fixed pixel distance (e.g., six pixels). Also, the number can be based on a characteristic of the object revised intensity data, such as the FWHM of the revised point spread function 222.

The subtraction 228 yields a final representation of the image 230 that includes final intensity data 232. In some embodiments, several axially-specific, zero-, and higher-order moments of the final representation of the image 230 (i.e., moments of the final intensity data 232 associated with each fluorescing object) are computed, as shown in Equations 4 through 13. Proceeding as described above in connection with Equations 14 through 23, a new set of coordinates (μ₁, μ₂) is computed for each fluorescing object. These new coordinates (μ₁, μ₂) are the final centroid 234 for each fluorescing object. In some embodiments, the final centroid 234 becomes the parameter 236 used in the comparison of the template and sample objects.

An illustration 231 of the final representation of the image 230 lacks many of the image artifacts present in the initial representation of the image 202. In particular, FIG. 3B shows several instances 231A, 231B, 231C, 231D, 231E where two fluorescing objects appear. Before deblending 200, many closely spaced pairs of fluorescing objects, such as those shown in FIG. 3B, would be erroneously rendered as single large objects, thereby preventing a proper analysis of, for example, chemical incorporations in DNA sequencing.

The process of fitting a point spread function to intensity data, subtracting the effect of the function from the data, and computing new centroids by the calculation of moments can be performed more than the two times described above. In theory, repeating the process will refine the image data, thereby reducing artifacts and allowing for the resolution of more (e.g., three or greater) closely spaced objects.

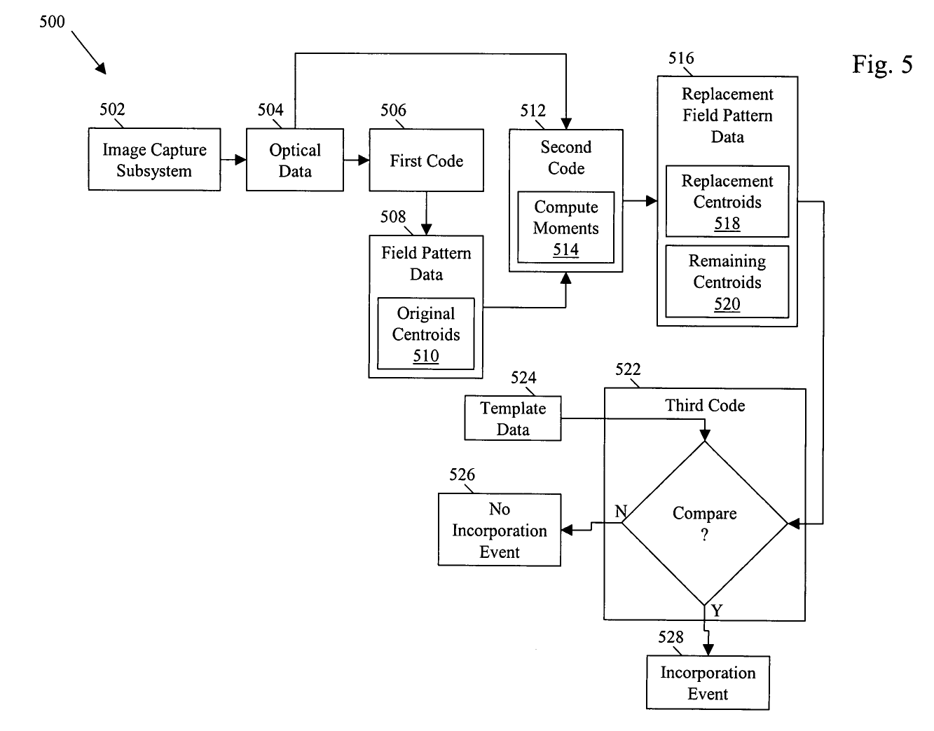

In brief overview, FIG. 5 is a block diagram depicting image analysis apparatus 500 in accordance with an embodiment of the invention. The apparatus 500 includes an image capture subsystem 502 that acquires images of fluorescing objects (i.e., template objects 104, or sample objects 120, or both), digitizes them, and generates corresponding optical data 504 that can be stored in computer files, typically in the FITS format. First software code 506 processes the optical data 504 and generates field pattern data 508 that includes original centroids 510 of the fluorescing objects. In the context of DNA sequencing, at least some of the original centroids 510 are associated with a single molecule of one of the nucleic acid sequences (i.e., DNA strands) adhered to a surface.

Second software code 512 processes the optical data 504, or the field pattern data 508, or both, computes the moments 514 of the intensity data corresponding to each fluorescing object, and generates a replacement field data pattern 516. From the computation of the moments 514, the second software code 512 also calculates replacement centroids 518. The apparatus 500 can repeat this process any number of times to refine the data.

The second software code 512 determines if any of the original centroids 510 should be replaced by two or more replacement centroids 518. This can occur when, for example, the moments 514 suggest that what was thought to be a single fluorescing object is actually two (or more) closely spaced fluorescing objects, each having its own centroid. For example, compare the fit of the image with a two centroid configuration with a fit of the image with a single centroid configuration. Apply a tolerance (e.g., 0.7-0.9) to the fit of the image with a single centroid configuration and choose which represents the better overall fit, typically still giving preference to the single centroid configuration. Consequently, the replacement field data pattern 516 typically includes both the replacement centroids 518 and any remaining centroids 520 (i.e., original centroids 510 left unchanged by the second software code 512 ).

The apparatus 500 includes third software code 522 for processing the replacement field data pattern 516 to determine if each of the centroids 518, 520 in the replacement field data pattern 516 is associated with a single molecule of one of the nucleic acid sequences. The third software code 522 generally does this by comparing the centroids of the template image with the centroids of the sample images. If the comparison reveals that the centroids are substantially equal (e.g., within an acceptance radius of about 0.8 pixel; of course, this value can vary depending on the quality of the optics and the amount of noise present, i.e., signal integrity), it can be concluded that an incorporation event 528 occurred. If the comparison reveals no substantial equality, it can be concluded that no incorporation event 526 occurred. As described above, repeating this process on images obtained after each chemical wash of the DNA strands allows the user to compile a list of the sequence of nucleotides in the strands.

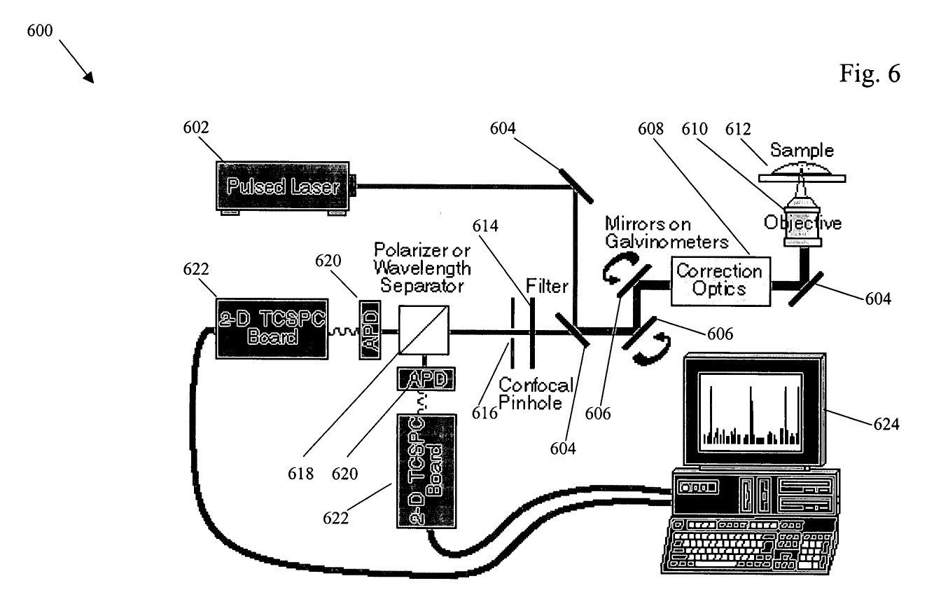

FIG. 6 is a representation of image analysis apparatus 600 in accordance with an embodiment of the invention. The apparatus 600 includes a pulsed laser 602 that produces a beam that is passed through a series of mirrors 604, mirrors coupled to galvanometers 606, correction optics 608, and an objective 610 to illuminate a sample 612 (e.g., the DNA strands attached to a surface). The laser beam is reflected by the sample and returns along its initial path and through a partially silvered mirror to a filter 614 and confocal pinhole 616. At this point, the reflected beam is separated into two beams based on polarization or wavelength by a separator 618. Each beam is then passed through dedicated avalanche photodiodes (“APDs”) 620 and image capture boards 622. Data from the image capture boards 622 are sent to a computer 624 for further processing (e.g., deblending) by one or more software programs running on the computer 624. The program(s) perform the processing operations describe herein, and all or some portions of the program(s) can be stored in the computer 624 on its hard drive and/or in its permanent and/or temporary memory. All or some portions of the program(s) can be stored on any program storage medium that is readable by a computer such as, for example, one or more of RAM, ROM, removable memory/storage devices, hard drives, CDs, etc. The computer 624 is depicted in FIG. 6 as a desktop personal computer, but it can be any other type of computer and in fact any type of computing device now known or later developed (e.g., handheld, laptop, server, workstation, supercomputer, networked device, etc.) running any operating system as long as it is capable of performing the processing operations described herein such as the deblending described herein.

FIG. 7 depicts a series of intensity peaks 700 for correlation in accordance with an embodiment of the invention. The representation of the template image 106 shows four intensity peaks representing the locations of the DNA strands on a surface. After a first series of chemical washes directed to a specific location 702 along the strands, one intensity peak is revealed. This intensity peak corresponds to one of the nucleotides and, because its location correlates (within a reasonable range of uncertainty) with the location of an intensity peak on the representation of the template image 106, it can be concluded that an incorporation event occurred. In other words, at this point on the DNA strand, a specific nucleotide is present.

A second series of chemical washes is then directed to the next location 704 along the DNA strands. At this point, three intensity peaks are revealed that have locations corresponding to the locations of intensity peaks on the representation of the template image 106. Accordingly, these incorporation events indicate that a specific nucleotide is present. The process repeats with a third series of chemical washes is then directed to the next location 706 along the DNA strands, and continues until the last location 708 in the DNA strands is subjected to the sequential washes and the locations of the fluorescing objects are compared. At this point the user has compiled a list of the sequence of nucleotides, and the DNA strands have been “sequenced.”

Note that embodiments of the invention can be used to analyze images unrelated to DNA sequencing. For example, any image that includes objects oriented in such a way to make resolution of them difficult may be subjected to the deblending process described herein. Performing one or more deblending “passes” on the image reduces artifacts and helps resolve the locations of the objects. When multiple images are to be compared, subjecting them to deblending before the comparisons increases accuracy.

Note that in FIGS. 1 through 7 the enumerated items are shown as individual elements. In actual implementations of the invention, however, they may be inseparable components of other electronic devices such as a digital computer. Thus, actions described above may be implemented in software that may be embodied in an article of manufacture that includes a program storage medium. The program storage medium includes, for example, data signals embodied in one or more of a carrier wave, a computer disk (magnetic, or optical (e.g., CD or DVD), or both), non-volatile memory, tape, a system memory, and a computer hard drive.

From the foregoing, it will be appreciated that methods and apparatus according to the invention afford a simple and effective way to analyze images used in DNA sequencing or in any other application where images must be examined or compared with accuracy and can be difficult to obtain due to, for example, defects in the testing apparatus and/or limitations on image resolution.

The invention may be embodied in other specific forms than what is particularly disclosed herein without departing from the spirit or scope of the invention. The foregoing disclosed embodiments are in all respects illustrative rather than limiting on the invention.

What is claimed is:

1. A method for identifying objects in an image, the method comprising the steps of:
selecting an object present in an image;
determining a plurality of moments associated with said object;
determining whether said plurality of moments is characteristic of a single object or multiple objects.

2. The method of claim 1, wherein said determining step comprises comparing said plurality of moments to a standard set of moments known to be associated with a single object.

3. The method of claim 2 wherein said comparing comprises the steps of:
determining a point spread function for said object;
fitting said point spread function to a point spread function for a known single object;
subtracting the effect of a quantity of the fitted point spread functions from the representation of the template image, thereby creating a revised representation of the template image that includes revised template object intensity data;
computing a plurality of revised template object centroids from the revised representation of the template image;
fitting a revised point spread function to the revised template object intensity data for each revised template object centroid;
subtracting the effect of a quantity of the fitted revised point spread functions from the revised representation of the template image, thereby creating a final representation of the template image; and
computing a plurality of final template object centroids from the final representation of the image.

4. The method of claim 3 wherein the quantity of fitted point spread functions is based at least in part on a pixel distance between the template object centroids.

5. The method of claim 3 wherein the quantity of fitted point spread functions is based at least in part on a fixed pixel distance.

6. The method of claim 5 wherein the fixed pixel distance is approximately 6 pixels.

7. The method of claim 3 wherein the quantity of fitted point spread functions is based at least in part on a characteristic of the template object intensity data.

8. The method of claim 7 wherein the characteristic of the template object intensity data comprises a full width half maximum of the template object intensity data.

9. The method of claim 3 wherein the revised template object centroids are computed from the template moments of the revised representation of the template image.

10. The method of claim 3 wherein the final template object centroids are computed from the template moments of the final representation of the template image.

11. The method of claim 3 wherein the quantity of fitted revised point spread functions is based at least in part on a pixel distance between the revised template object centroids.

12. The method of claim 3 wherein the quantity of fitted revised point spread functions is based at least in part on a fixed pixel distance.

13. The method of claim 12 wherein the fixed pixel distance is approximately 6 pixels.

14. The method of claim 3 wherein the quantity of fitted revised point spread functions is based at least in part on a characteristic of the revised template object intensity data.

15. The method of claim 14 wherein the characteristic of the revised template object intensity data comprises a full width half maximum of the revised template object intensity data.

16. The method of claim 3 wherein at least one of the point spread function or the revised point spread function comprises a Gaussian function.

17. The method of claim 3 wherein the step of comparing comprises the steps of:
fitting the point spread function to the sample object intensity data for each sample object centroid;
subtracting the effect of a quantity of fitted point spread functions from the representation of the sample image, thereby creating a revised representation of the sample image that includes revised sample object intensity data;
computing a plurality of revised sample object centroids from the revised representation of the sample image;
fitting a revised point spread function to the revised sample object intensity data for each revised sample object centroid;
subtracting the effect of a quantity of fitted revised point spread functions from the revised representation of the sample image, thereby creating a final representation of the sample image; and
computing a plurality of final sample object centroids from the final representation of the sample image.

18. The method of claim 17 wherein the sample parameter comprises at least one of the final sample object centroids.

19. The method of claim 17 wherein the quantity of fitted point spread functions is based at least in part on a pixel distance between the sample object centroids.

20. The method of claim 17 wherein the quantity of fitted point spread functions is based at least in part on a fixed pixel distance.

21. The method of claim 20 wherein the fixed pixel distance is approximately 6 pixels.

22. The method of claim 17 wherein the quantity of fitted point spread functions is based at least in part on a characteristic of the sample object intensity data.

23. The method of claim 22 wherein the characteristic of the sample object intensity data comprises a full width half maximum of the sample object intensity data.

24. The method of claim 17 wherein the revised sample object centroids are computed from the sample moments of the revised representation of the sample image.

25. The method of claim 17 wherein the final sample object centroids are computed from the sample moments of the final representation of the sample image.

26. The method of claim 17 wherein the quantity of fitted revised point spread functions is based at least in part on a pixel distance between the revised sample object centroids.

27. The method of claim 17 wherein the quantity of fitted revised point spread functions is based at least in part on a fixed pixel distance.

28. The method of claim 27 wherein the fixed pixel distance is approximately 6 pixels.

29. The method of claim 17 wherein the quantity of fitted revised point spread functions is based at least in part on a characteristic of the revised sample object intensity data.

30. The method of claim 29 wherein the characteristic of the revised sample object intensity data comprises a full width half maximum of the revised sample object intensity data.

31. The method of claim 17 wherein at least one of the point spread function or the revised point spread function comprises a Gaussian function.

32. Image analysis apparatus for use in a single-molecule detection system, the image processing apparatus comprising:
an image capture subsystem for receiving optical information from a plurality of nucleic acid sequences adhered to a surface and for generating a first set of data representative of the optical information;
first software code for processing the first set of data to create a second set of data representative of a two-dimensional field pattern that includes a plurality of original centroids, each of at least some of the original centroids being associated with a single molecule of one of the nucleic acid sequences;
second software code for processing at least one of the first or second sets of data to determine if any of the original centroids should be replaced by two or more replacement centroids, the second software code creating a third set of data representative of a replacement two-dimensional field pattern that includes the replacement centroids and any remaining original centroids; and
third software code for processing the third set of data to determine if each of the centroids in the replacement two-dimensional field pattern is associated with a single molecule of one of the nucleic acid sequences.

33. The apparatus of claim 32 wherein the second software code calculates several moments associated with at least the original centroids.

34. The apparatus of claim 32 wherein the third software code compares the third set of data with template data to determine if each of the centroids in the replacement two-dimensional field pattern is associated with a single molecule of one of the nucleic acid sequences.

35. An image analysis method for use in connection with a single-molecule detection system, the method comprising the steps of:
receiving optical information from a plurality of nucleic acid sequences adhered to a surface;
generating a first set of data representative of the optical information;
processing the first set of data to create a second set of data representative of a two-dimensional field pattern that includes a plurality of original centroids, each of at least some of the original centroids being associated with a single molecule of one of the nucleic acid sequences;
processing at least one of the first or second sets of data to determine if any of the original centroids should be replaced by two or more replacement centroids;
creating a third set of data representative of a replacement two-dimensional field pattern that includes the replacement centroids and any remaining original centroids; and
processing the third set of data to determine if each of the centroids in the replacement two-dimensional field pattern is associated with a single molecule of one of the nucleic acid sequences.

36. The method of claim 35 wherein the step of processing at least one of the first or second sets of data comprises calculating several moments associated with at least the original centroids.

37. The method of claim 35 wherein the step of processing the third set of data comprises comparing the third set of data with template data to determine if each of the centroids in the replacement two-dimensional field pattern is associated with a single molecule of one of the nucleic acid sequences.

38. An image analysis method comprising the steps of:
providing a representation of a template image, the template image including a plurality of template objects, and the representation including template object intensity data associated with each template object and template object centroids;
performing a deblending procedure on the representation of the template image, the deblending procedure comprising the computation of several template moments and the generation of a template parameter;
providing a representation of a sample image, the sample image including a plurality of sample objects, and the representation including sample object intensity data associated with each sample object and sample object centroids;
performing a deblending procedure on the representation of the sample image, the deblending procedure comprising the computation of several sample moments and the generation of a sample parameter; and
determining whether the sample parameter is substantially equal to the template parameter.

39. The method of claim 38 wherein the deblending procedure on the representation of the template image and the deblending procedure on the representation of the sample image comprise the use of a known point spread function.

40. The method of claim 39 wherein the step of performing a deblending procedure on the representation of the template image comprises the steps of:
fitting the point spread function to the template object intensity data for each template object centroid;
subtracting the effect of a quantity of the fitted point spread functions from the representation of the template image, thereby creating a revised representation of the template image that includes revised template object intensity data;
computing a plurality of revised template object centroids from the revised representation of the template image;
fitting a revised point spread function to the revised template object intensity data for each revised template object centroid;
subtracting the effect of a quantity of the fitted revised point spread functions from the revised representation of the template image, thereby creating a final representation of the template image; and
computing a plurality of final template object centroids from the final representation of the image.

41. The method of claim 39 wherein the step of performing a deblending procedure on the representation of the sample image comprises the steps of:
fitting the point spread function to the sample object intensity data for each sample object centroid;
subtracting the effect of a quantity of fitted point spread function from the representation of the sample image, thereby creating a revised representation of the sample image that includes revised sample object intensity data;
computing a plurality of revised sample object centroids from the revised representation of the sample image;
fitting a revised point spread function to the revised sample object intensity data for each revised sample object centroid;
subtracting the effect of a quantity of fitted revised point spread function from the revised representation of the sample image, thereby creating a final representation of the sample image; and
computing a plurality of final sample object centroids from the final representation of the sample image.

42. An article of manufacture comprising a program storage medium having computer readable program code embodied therein for performing image analysis, the computer readable program code in the article of manufacture including:
computer readable code for causing a computer to provide a representation of a template image, the template image including a plurality of template objects, and the representation including template object intensity data associated with each template object and template object centroids;
computer readable code for causing a computer to perform a deblending procedure on the representation of the template image, the deblending procedure comprising the computation of several template moments and the generation of a template parameter;
computer readable code for causing a computer to provide a representation of a sample image, the sample image including a plurality of sample objects, and the representation including sample object intensity data associated with each sample object and sample object centroids;
computer readable code for causing a computer to perform a deblending procedure on the representation of the sample image, the deblending procedure comprising the computation of several sample moments and the generation of a sample parameter; and
computer readable code for causing a computer to determine whether the sample parameter is substantially equal to the template parameter, so as to provide the image analysis.

43. A program storage medium readable by a computer, tangibly embodying a program of instructions executable by the computer to perform method steps for performing image analysis, the method steps comprising:
providing a representation of a template image, the template image including a plurality of template objects, and the representation including template object intensity data associated with each template object and template object centroids;
performing a deblending procedure on the representation of the template image, the deblending procedure comprising the computation of several template moments and the generation of a template parameter;
providing a representation of a sample image, the sample image including a plurality of sample objects, and the representation including sample object intensity data associated with each sample object and sample object centroids;
performing a deblending procedure on the representation of the sample image, the deblending procedure comprising the computation of several sample moments and the generation of a sample parameter; and
determining whether the sample parameter is substantially equal to the template parameter.
